(19) United States
(12) Patent Application Publication
(10) Pub. No.: US 2025/0170725 A1
(43) Pub. Date: May 29, 2025

(54) ROBOT SYSTEM

(71) Applicant: SEIKO EPSON CORPORATION, Tokyo (JP)

(72) Inventor: Masaki MOTOYOSHI, AZUMINO-SHI (JP)

(21) Appl. No.: 18/960,960

(22) Filed: Nov. 26, 2024

(30) Foreign Application Priority Data
Nov. 28, 2023 (JP) 2023-201029

(51) Int. Cl. B25J 13/08; B25J 9/00

(52) U.S. Cl. CPC B25J 13/088; B25J 9/0009

(57) ABSTRACT

A robot system includes: a robot including a robot arm that includes a plurality of arms and a plurality of joints, the plurality of joints including a proximal end side joint and a distal end side joint positioned on a distal end side of the proximal end side joint, and the proximal end side joint and the distal end side joint having rotation axes parallel to each other; and an inertial sensor disposed on an arm that connects the distal end side joint and a joint positioned at a position distal to the distal end side joint, in which the inertial sensor detects an angular velocity around an axis parallel to the rotation axes, and an acceleration in a direction orthogonal to a central axis of the arm on which the inertial sensor is disposed and orthogonal to the rotation axes.

### CROSS-REFERENCE TO RELATED APPLICATIONS

The present application is based on, and claims priority from JP Application Serial Number 2023-201029, filed Nov. 28, 2023, the disclosure of which is hereby incorporated by reference herein in its entirety.

### BACKGROUND OF THE INVENTION

### 1. Technical Field

The present disclosure relates to a robot system.

### 2. Related Art

A manipulator described in JP-A-2022-177607 includes an arm including a plurality of joints, an actuator disposed at each of the joints, an end effector coupled to a distal end portion of the arm, and an acceleration sensor disposed at the end effector. In the manipulator having such a configuration, the acceleration sensor detects vibration of the end effector and controls the vibration based on a detection result.

However, in the manipulator of JP-A-2022-177607, it is not possible to determine which of the plurality of joints included in the arm is causing the vibration of the end effector. Therefore, it is difficult to effectively control the vibration.

### SUMMARY OF THE INVENTION

According to an aspect of the present disclosure, a robot system includes: a robot including a robot arm that includes a plurality of arms and a plurality of joints, the plurality of joints including a proximal end side joint and a distal end side joint positioned on a distal end side of the proximal end side joint, and the proximal end side joint and the distal end side joint having rotation axes parallel to each other; and an inertial sensor disposed on an arm that connects the distal end side joint and a joint positioned at a position distal to the distal end side joint, in which the inertial sensor detects an angular velocity around an axis parallel to the rotation axes, and an acceleration in a direction orthogonal to a central axis of the arm on which the inertial sensor is disposed and orthogonal to the rotation axes.

According to an aspect of the present disclosure, a robot system includes: a robot including a robot arm that includes a plurality of arms and a plurality of joints, the plurality of joints including a proximal end side joint and a distal end side joint positioned on a distal end side of the proximal end side joint, and the proximal end side joint and the distal end side joint having rotation axes parallel to each other; and an inertial sensor disposed on an arm that connects a joint positioned at a position distal to the distal end side joint and a joint positioned at a position further distal to the distal end side joint, in which the inertial sensor detects an angular velocity around an axis parallel to the rotation axes, and an acceleration in a direction orthogonal to a central axis of the arm on which the inertial sensor is disposed and orthogonal to the rotation axes.

According to an aspect of the present disclosure, a robot system includes: a robot including a robot arm that includes a plurality of arms and a plurality of joints, the plurality of joints including a proximal end side joint and a distal end side joint positioned on a distal end side of the proximal end side joint, and the proximal end side joint and the distal end side joint having rotation axes parallel to each other; and an inertial sensor disposed on an arm that is positioned between the distal end side joint and a joint positioned on the most distal end side, in which the inertial sensor detects an angular velocity around an axis parallel to the rotation axes, and an acceleration in a direction orthogonal to a central axis of the arm on which the inertial sensor is disposed and orthogonal to the rotation axes.

### BRIEF DESCRIPTION OF DRAWINGS

FIG. 1 is an overall diagram of a robot system according to a first embodiment.

FIG. 2 is a schematic diagram illustrating a posture in which a vibration amount of each of second and third joints cannot be detected based on an acceleration alone.

FIG. 3 is a schematic diagram illustrating a posture in which the vibration amount of each of the second and third joints cannot be detected based on an angular velocity alone.

FIG. 4 is a flowchart illustrating a robot control process.

FIG. 5 is a schematic diagram for describing a method for detecting the vibration amount of each of the second and third joints.

FIG. 6 is a schematic diagram for describing the method for detecting the vibration amount of each of the second and third joints.

FIG. 7 is a schematic diagram for describing the method for detecting the vibration amount of each of the second and third joints.

FIG. 8 is a schematic diagram for describing the method for detecting the vibration amount of each of the second and third joints.

FIG. 9 is a schematic diagram for describing the method for detecting the vibration amount of each of the second and third joints.

FIG. 10 is a schematic diagram for describing the method for detecting the vibration amount of each of the second and third joints.

FIG. 11 is a block diagram illustrating a configuration of a control unit included in a control device.

FIG. 12 is a diagram illustrating an example of an arrangement of an inertial sensor.

FIG. 13 is a diagram illustrating an example of an arrangement of the inertial sensor.

FIG. 14 is a diagram illustrating an example of an arrangement of the inertial sensor.

FIG. 15 is a diagram illustrating an example of an arrangement of the inertial sensor.

FIG. 16 is a schematic diagram illustrating a robot according to a second embodiment.

FIG. 17 is a diagram illustrating an arrangement of an inertial sensor.

FIG. 18 is a schematic diagram illustrating a robot according to a third embodiment.

FIG. 19 is a schematic diagram illustrating a robot according to a fourth embodiment.

FIG. 20 is a schematic diagram illustrating a robot according to a fifth embodiment.

FIG. 21 is a diagram illustrating a robot according to a sixth embodiment.

### DETAILED DESCRIPTION OF THE INVENTION

Hereinafter, a robot system according to the present disclosure will be described in detail based on embodiments illustrated in the accompanying drawings.

### First Embodiment

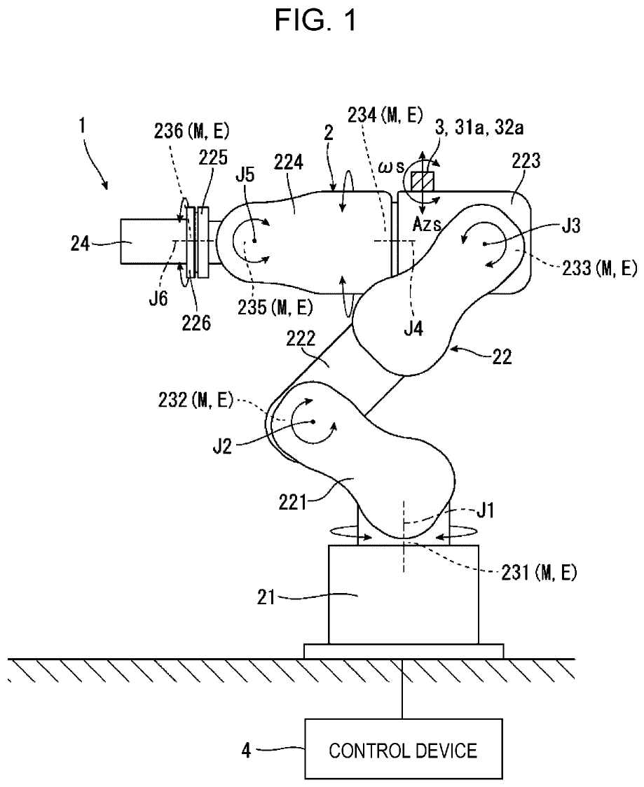

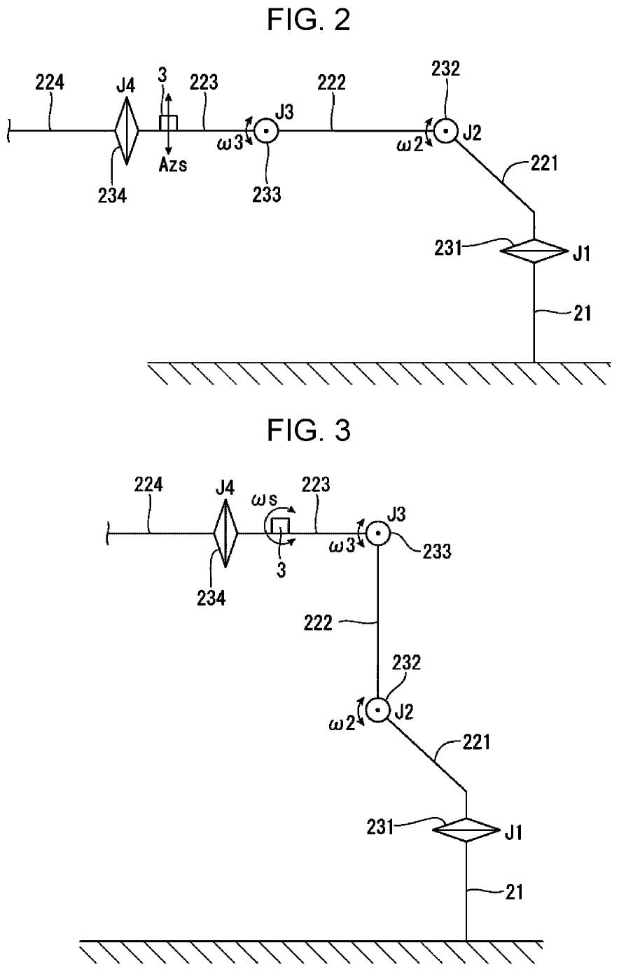

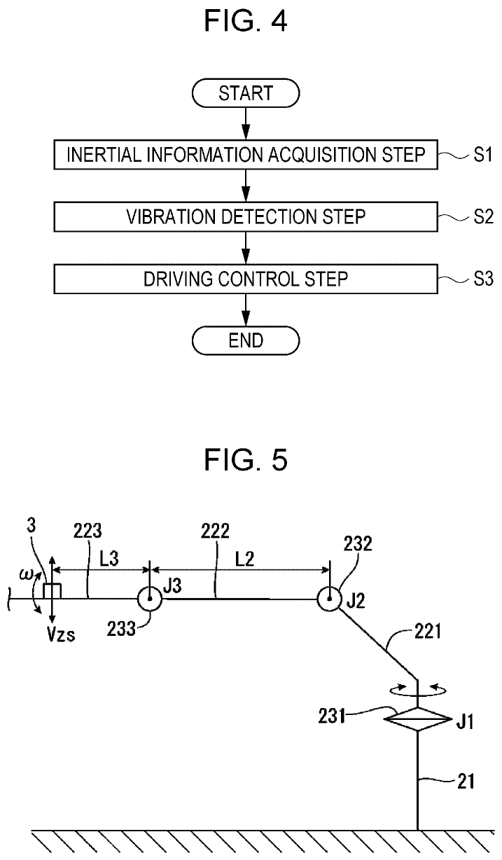

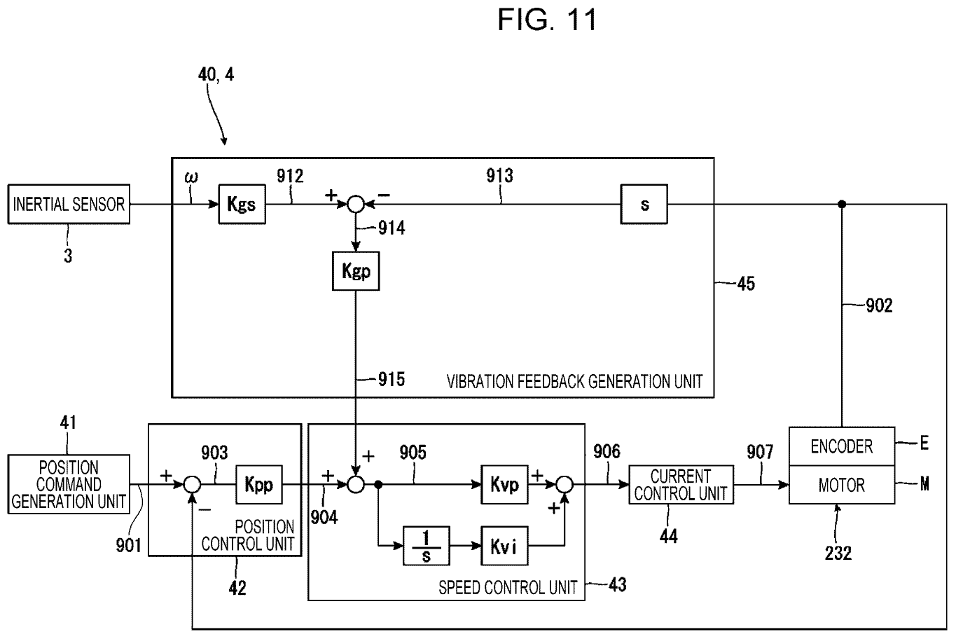

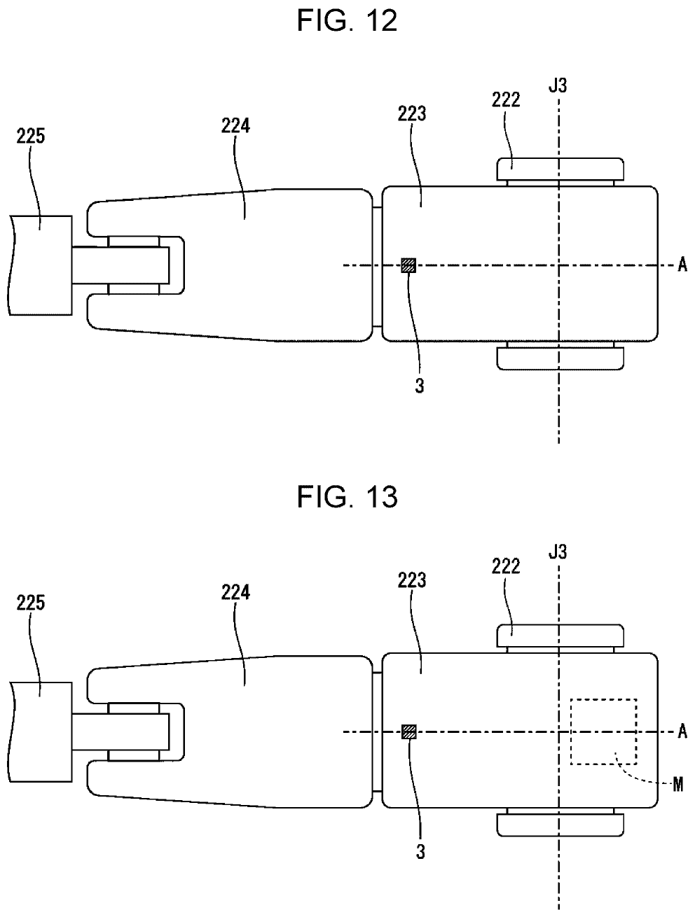

FIG. 1 is an overall diagram of a robot system according to a first embodiment. FIG. 2 is a schematic diagram illustrating a posture in which a vibration amount of each of second and third joints cannot be detected based on an acceleration alone. FIG. 3 is a schematic diagram illustrating a posture in which the vibration amount of each of the second and third joints cannot be detected based on an angular velocity alone. FIG. 4 is a flowchart illustrating a robot control process. Each of FIGS. 5 to 10 is a schematic diagram for describing a method for detecting the vibration amount of each of the second and third joints. FIG. 11 is a block diagram illustrating a configuration of a control unit included in a control device. Each of FIGS. 12 to 15 is a diagram illustrating an example of an arrangement of an inertial sensor.

A robot system 1 illustrated in FIG. 1 includes a robot 2, an inertial sensor 3 disposed on the robot 2, and a control device 4 that controls driving of the robot 2.

The robot 2 is a 6-axis vertical articulated robot having six drive axes, and includes a base 21 and a robot arm 22 rotatably connected to the base 21. The robot arm 22 has a configuration in which first, second, third, fourth, fifth, and sixth arms 221, 222, 223, 224, 225, and 226 are coupled via first, second, third, fourth, fifth, and sixth joints 231, 232, 233, 234, 235, and 236. Here, the second joint 232 is a joint positioned at a position distal to the first joint 231, the third joint 233 is a joint positioned at a position distal to the second joint 232, the fourth joint 234 is a joint positioned at a position distal to the third joint 233, the fifth joint 235 is a joint positioned at a position distal to the fourth joint 234, and the sixth joint 236 is a joint positioned at a position distal to the fifth joint 235.

The first arm 221 is coupled to the base 21 via the first joint 231 so as to be rotatable around a first rotation axis J1. The second arm 222 is coupled to the first arm 221 via the second joint 232 so as to be rotatable around a second rotation axis J2. The third arm 223 is coupled to the second arm 222 via the third joint 233 so as to be rotatable around a third rotation axis J3. The fourth arm 224 is coupled to the third arm 223 via the fourth joint 234 so as to be rotatable around a fourth rotation axis J4. The fifth arm 225 is coupled to the fourth arm 224 via the fifth joint 235 so as to be rotatable around a fifth rotation axis J5. The sixth arm 226 is coupled to the fifth arm 225 via the sixth joint 236 so as to be rotatable around a sixth rotation axis J6.

Among the joints 231, 232, 233, 234, 235, and 236, the second, third, and fifth joints 232, 233, and 235 are bending joints, and the first, fourth, and sixth joints 231, 234, and 236 are twisting joints. The second rotation axis J2 is orthogonal to the first rotation axis J1, the third rotation axis J3 is parallel to the second rotation axis J2, the fourth rotation axis J4 is orthogonal to the third rotation axis J3, the fifth rotation axis J5 is orthogonal to the fourth rotation axis J4, and the sixth rotation axis J6 is orthogonal to the fifth rotation axis J5. The second, third, and fifth rotation axes J2, J3, and J5 are each oriented in a horizontal direction.

In the present specification, the term “parallel” not only refers to a case where the axes are parallel to each other, but also includes a case where there is a deviation to the extent that the axes can be regarded as equivalent to parallel from a technical common sense perspective, like a case where there is a deviation that can occur due to dimensional accuracy or assembly precision of the robot 2. Further, the term “orthogonal” not only refers to a case where the axes are orthogonal to each other, but also includes a case where there is a deviation that can be regarded as equivalent to orthogonal from a technical common sense perspective, like a case where there is a deviation that can occur due to dimensional accuracy or assembly precision of the robot 2.

In such a robot 2, the second joint 232 is a “proximal end side joint” of the present application, and the third joint 233 is a “distal end side joint” of the present application.

Each of the joints 231, 232, 233, 234, 235, and 236 includes a motor M, a speed reducer (not illustrated) that reduces a rotation speed of the motor M and outputs the reduced rotation speed, and an encoder E that detects a rotation amount of the motor M. The control device 4 drives the motor M by servo control of feeding back an output of the encoder E, thereby controlling a rotation amount of each of the joints 231, 232, 233, 234, 235, and 236.

An end effector 24 is mounted on a distal end portion of the robot arm 22, that is, the sixth arm 226. The end effector 24 is attachable to and detachable from the sixth arm 226, and is mounted according to work to be performed by the robot 2 as appropriate.

As illustrated in FIG. 1, the inertial sensor 3 is disposed on the third arm 223. The inertial sensor 3 includes an angular velocity detection element 31a that detects an angular velocity ωs around an axis in the same direction as the second and third rotation axes J2 and J3, and an acceleration detection element 32a that detects an acceleration Azs in a direction orthogonal to a central axis A of the third arm 223 and orthogonal to the second and third rotation axes J2 and J3. More specifically, the acceleration Azs is a vertical acceleration resulting from a rotational motion of the third arm 223 caused by driving of at least one of the second and third joints 232 and 232. By disposing the inertial sensor 3 on the third arm 223, a detection axis of the angular velocity detection element 31a is maintained to be parallel to the second and third rotation axes J2 and J3 and a detection axis of the acceleration detection element 32a is maintained to be orthogonal to the second and third rotation axes J2 and J3 in any posture, so that the angular velocity ωs and the acceleration Azs can be detected more reliably.

As described above, the inertial sensor 3 is disposed on the third arm 223, and thus, it can be said that the inertial sensor 3 is disposed on an arm positioned between the third joint 233, which is the distal end side joint, and the sixth joint 236, which is positioned on the most distal end side. In other words, it can be said that the inertial sensor 3 is not disposed on the sixth arm 226. In this way, as the inertial sensor 3 is disposed so as to avoid an arm positioned at the most distal end, the number of joints between the inertial sensor 3 and the third joint 233 can be kept as small as possible. Therefore, it becomes easier to detect the angular velocity ωs and the acceleration Azs without being affected by the posture of the robot arm 22.

In the present embodiment, one sensor unit including the angular velocity detection element 31a and the acceleration detection element 32a is used as the inertial sensor 3, but the present disclosure is not limited thereto. An angular velocity sensor including the angular velocity detection element 31a and an acceleration sensor including the acceleration detection element 32a may be separately provided.

The control device 4 controls the driving of the robot 2. The control device 4 is implemented by, for example, a computer, and includes a processor (central processing unit (CPU)) for processing information, a memory communicably coupled to the processor, and an external interface for coupling to an external device. Various programs executable by the processor are stored in the memory, and the processor can read and execute the programs and the like stored in the memory.

The configuration of the robot system 1 has been described above. For example, when the inertial sensor 3 can only detect the acceleration Azs, it is not possible to distinguish between an angular velocity ω2 resulting from the vibration of the second joint 232 and an angular velocity ω3 resulting from the vibration of the third joint 233 in a posture in which the second and third arms 222 and 223 are both extended in the horizontal direction as illustrated in FIG. 2. Further, for example, when the inertial sensor 3 can only detect the angular velocity ωs, it is not possible to distinguish between the angular velocity ω2 resulting from the vibration of the second joint 232 and the angular velocity ω3 resulting from the vibration of the third joint 233 in a posture in which the second arm 222 is directed in the vertical direction, the third arm 223 is directed in the horizontal direction, and the second and third arms 222 and 223 are orthogonal to each other as illustrated in FIG. 3. On the other hand, in the robot system 1, the inertial sensor 3 can detect both of the angular velocity ωs and the acceleration Azs, and it is possible to distinguish between the vibration of the second joint 232 and the vibration of the third joint 233 based on a relationship between the angular velocity ωs and the acceleration Azs. Hereinafter, the method will be described.

As illustrated in FIG. 4, a control method for the robot 2 includes an inertial information acquisition step S1 of acquiring the angular velocity ωs and the acceleration Azs from the inertial sensor 3, a vibration detection step S2 of detecting a vibration amount of each of the second joint 232 and the third joint 233 based on the angular velocity ωs and acceleration Azs acquired in the inertial information acquisition step S1, and a driving control step S3 of controlling vibration based on the vibration amount of each joint according to a detection result of the vibration detection step S2. Each of steps S1 to S3 will be described in detail below.

### Inertial Information Acquisition Step S1

In the inertial information acquisition step S1, the control device 4 acquires the angular velocity ωs and the acceleration Azs from the inertial sensor 3.

### Vibration Detection Step S2

In the vibration detection step S2, the control device 4 detects the vibration amount of each of the second joint 232 and the third joint 233 based on the angular velocity ωs and the acceleration Azs acquired in the inertial information acquisition step S1.

As an example, a detection method in the case of a posture in which the second arm 222 and the third arm 223 are extended straight in the horizontal direction as illustrated in FIG. 5 will be described. As described above, in such a posture, the vibration amount of each of the second joint 232 and the third joint 233 cannot be detected based on the acceleration Azs alone. Also, as illustrated in FIG. 5, a distance between the second rotation axis J2 and the third rotation axis J3 is L2, and a distance between the third rotation axis J3 and the inertial sensor 3 is L3. In FIG. 5, a vertical translational velocity Vzs of the inertial sensor 3 is expressed as Vzs=L′ω. The translational velocity Vzs is calculated by integrating the acceleration Azs detected by the inertial sensor 3. L is a distance between a rotation axis of a joint where vibration is occurring and the inertial sensor 3, and ω is an angular velocity around the rotation axis of the joint where vibration is occurring.

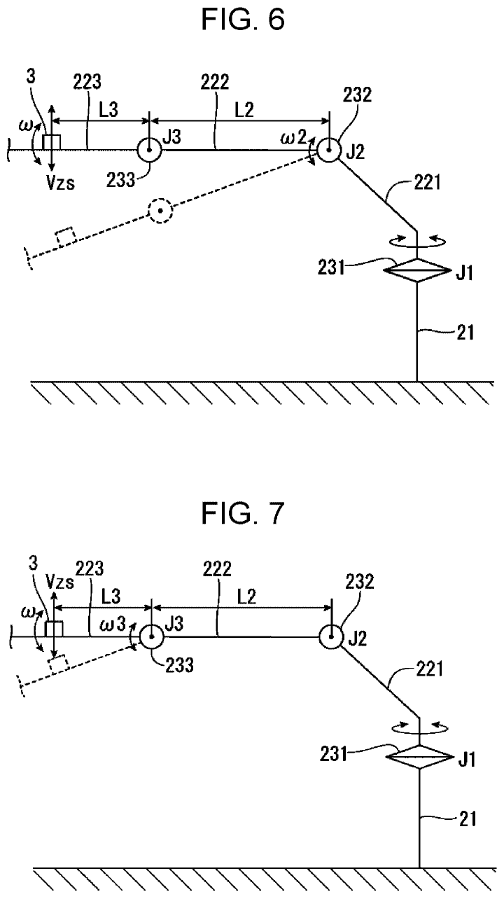

When the second joint 232 vibrates at the angular velocity ω2 as illustrated in FIG. 6, Vzs=(L2+L3)×ω2, and ω=ω2. On the other hand, when the third joint 233 vibrates at the angular velocity ω3 as illustrated in FIG. 7, Vzs=L3×ω3, and ω=ω3. In this way, a relationship between the translational velocity Vzs and the angular velocity ω differs between a case where the second joint 232 vibrates and a case where the third joint 233 vibrates. Specifically, Vzs/ω when the second joint 232 vibrates is greater than Vzs/ω when the third joint 233 vibrates. Therefore, the vibration amount of each of the second joint 232 and the third joint 233 can be determined based on the relationship between the translational velocity Vzs and the angular velocity ω.

From the above relationship, the following Equations (1) and (2) using the Jacobian matrix hold. Therefore, the angular velocities ω2 and ω3 can be calculated based on L2 and L3 measured in advance, the angular velocity ωs detected by the inertial sensor 3, and the translational velocity Vzs calculated from the acceleration Azs detected by the inertial sensor 3. Then, the vibration amount of each of the second joint 232 and the third joint 233 can be determined based on the calculated values of the angular velocities ω2 and ω3.

$$\begin{matrix}Equation ( 1 ) & \\ [ \begin{matrix}Vzs \\ ω s\end{matrix} ] = [ \begin{matrix}( L 2 + L 3 ) & L 3 \\ 1 & 1\end{matrix} ] [ \begin{matrix}ω 2 \\ ω 3\end{matrix} ] & ( 1 )\end{matrix}$$

$$\begin{matrix}Equation ( 2 ) & \\ [ \begin{matrix}ω 2 \\ ω 3\end{matrix} ] = {[ \begin{matrix}( L 2 + L 3 ) & L 3 \\ 1 & 1\end{matrix} ]}^{- 1} [ \begin{matrix}Vzs \\ ω s\end{matrix} ] & ( 2 )\end{matrix}$$

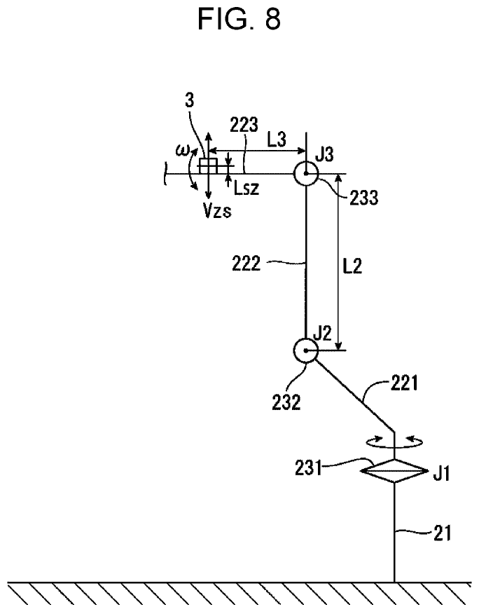

As another example, a posture in which the second arm 222 is directed in the vertical direction, the third arm 223 is directed in the horizontal direction, and the second and third arms 222 and 223 are orthogonal to each other as illustrated in FIG. 8 will be described. In this case, a distance from the center of the third arm 223 to a detection center of the acceleration detected by the inertial sensor 3 in the vertical direction is Lsz. As described above, in such a posture, the vibration amount of each of the second joint 232 and the third joint 233 cannot be detected based on the angular velocity ωs alone.

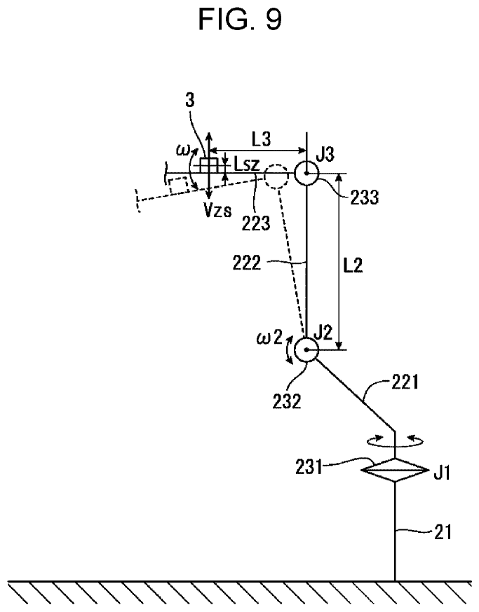

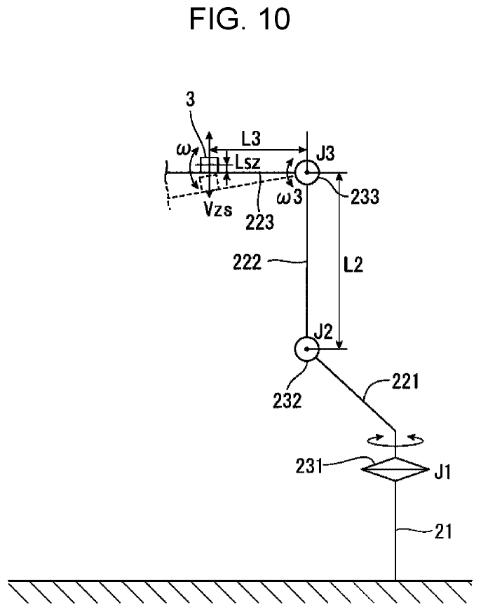

As illustrated in FIG. 9, when the second joint 232 vibrates at the angular velocity ω2, Vzs=L3× ω2, and ω=ω2. On the other hand, when the third joint 233 vibrates at the angular velocity ω3 as illustrated in FIG. 10, Vzs=√(L3²+Lsz²)×ω3, and ω=ω3. In this way, the relationship between the translational velocity Vzs and the angular velocity ω differs between a case where the second joint 232 vibrates and a case where the third joint 233 vibrates. Therefore, the vibration amount of each of the second joint 232 and the third joint 233 can be determined based on the relationship between the translational velocity Vzs and the angular velocity ω.

From the above relationship, the following Equations (3) and (4) using the Jacobian matrix hold. Therefore, the angular velocities ω2 and ω3 can be calculated based on L2, L3, and Lsz measured in advance, the angular velocity ωs detected by the inertial sensor 3, and the translational velocity Vzs calculated from the acceleration Azs detected by the inertial sensor 3. Then, the vibration amount of each of the second joint 232 and the third joint 233 can be determined based on the calculated values of the angular velocities ω2 and ω3.

$$\begin{matrix}Equation ( 3 ) & \\ [ \begin{matrix}Vzs \\ ω s\end{matrix} ] = [ \begin{matrix}L 3 & \sqrt{L 3 + {Lsz}^{2}} \\ 1 & 1\end{matrix} ] [ \begin{matrix}ω 2 \\ ω 3\end{matrix} ] & ( 3 )\end{matrix}$$

$$\begin{matrix}Equation ( 4 ) & \\ [ \begin{matrix}ω 2 \\ ω 3\end{matrix} ] = {[ \begin{matrix}L 3 & \sqrt{L 3 + {Lsz}^{2}} \\ 1 & 1\end{matrix} ]}^{- 1} [ \begin{matrix}Vzs \\ ω s\end{matrix} ] & ( 4 )\end{matrix}$$

Hereinabove, two typical postures in which the vibration amount of each of the second joint 232 and the third joint 233 cannot be determined based on only one of the angular velocity ωs and the acceleration Azs have been described. However, it is a matter of course that it is possible to determine the vibration amount of each of the second joint 232 and the third joint 233 based on the relationship between the angular velocity ωs and the acceleration Azs in other postures as well.

In the robot 2, the following Equations (5) and (6) using a Jacobian matrix J hold in any posture. The Jacobian matrix J indicates a position of the inertial sensor 3, and has different values depending on the rotation amounts of the second and third joints 232 and 233. The position of the inertial sensor 3 is detected, for example, based on the output of the encoder E included in each of the second and third joints 232 and 233. Therefore, the angular velocities ω2 and ω3 can be calculated based on the distances L2, L3, and Lsz measured in advance, the angular velocity ωs detected by the inertial sensor 3, and the translational velocity Vzs calculated from the acceleration Azs detected by the inertial sensor 3. Then, the vibration amount of each of the second joint 232 and the third joint 233 can be determined based on the calculated values of the angular velocities ω2 and ω3.

$$\begin{matrix}Equation ( 5 ) & \\ [ \begin{matrix}Vzs \\ ω s\end{matrix} ] = J [ \begin{matrix}ω 2 \\ ω 3\end{matrix} ] & ( 5 )\end{matrix}$$

$$\begin{matrix}Equation ( 6 ) & \\ [ \begin{matrix}ω 2 \\ ω 3\end{matrix} ] = {J}^{- 1} [ \begin{matrix}Vzs \\ ω s\end{matrix} ] & ( 6 )\end{matrix}$$

According to the method as described above, the vibration amount of each of the second joint 232 and the third joint 233 can be determined. In particular, the vibration amount of each of the second joint 232 and the third joint 233 can be determined based on the distances L2, L3, and Lsz measured in advance, the angular velocity ωs detected by the inertial sensor 3, and the translational velocity Vzs calculated from the acceleration Azs detected by the inertial sensor 3, so that the detection can be easily performed.

### Driving Control Step S3

In the driving control step S3, the control device 4 controls the driving of the robot arm 22 based on the detection result of the vibration detection step S2. Specifically, the control device 4 controls the second joint 232 and the third joint 233 based on the vibration amount of each joint determined in the vibration detection step S2. In this way, more appropriate control can be performed by controlling the vibration based on the vibration amount of each joint, so that it is possible to more reliably and effectively reduce the vibration.

Here, a case of controlling the second joint 232 will be described as an example. As illustrated in FIG. 11, the control device 4 includes a control unit 40 that controls driving of the second joint 232. The control unit 40 includes a position command generation unit 41, a position control unit 42, a speed control unit 43, a current control unit 44, and a vibration feedback generation unit 45.

The vibration feedback generation unit 45 multiplies the angular velocity ω, which is the vibration amount determined in step S2 based on the angular velocity ωs detected by the inertial sensor 3 and the acceleration Azs detected by the inertial sensor 3, by an arm angular velocity scaling coefficient Kgs to calculate a motor-shaft-converted arm angular velocity 912. The vibration feedback generation unit 45 also performs time differentiation on a motor shaft position 902, which is a rotation angle of the motor M detected by the encoder E, to calculate a motor shaft angular velocity 913 which is an angular velocity of a motor shaft. Next, the vibration feedback generation unit 45 subtracts the motor shaft angular velocity 913 from the motor-shaft-converted arm angular velocity 912 to calculate a vibration angular velocity 914. Next, the vibration feedback generation unit 45 multiplies the vibration angular velocity 914 by a feedback gain Kgp to calculate a vibration feedback 915.

The position command generation unit 41 generates a position command 901 for the motor M based on a program created by a host computer. The position control unit 42 first calculates a position deviation 903 by subtracting the motor shaft position 902 detected by the encoder E from the position command 901. Next, the position control unit 42 calculates a speed command 904 by multiplying the position deviation 903 by a position loop proportional gain Kpp.

The speed control unit 43 is implemented by proportional and integral control. The speed control unit 43 first calculates a speed loop command 905 by adding the speed command 904 and the vibration feedback 915 generated by the vibration feedback generation unit 45. Next, the speed control unit 43 calculates a current command 906 by adding an integral term obtained by multiplying an integral value of the speed loop command 905 by a speed loop integral gain Kvi to a proportional term obtained by multiplying the speed loop command 905 by a speed loop proportional gain Kvp.

The current control unit 44 controls a current 907 that drives the motor M in such a way that the current 907 matches the current command 906, that is, the current 907 follows the current command 906. The motor M is then driven by the current 907 controlled by the current control unit 44.

An example of the control has been described above. Next, several examples of an arrangement of the inertial sensor 3 will be described. For example, the inertial sensor 3 is positioned on the central axis A of the third arm 223 in plan view when viewed from the vertical direction, that is, from a direction orthogonal to the third rotation axis J3 and the central axis A of the third arm 223 as illustrated in FIG. 12. In the robot system 1, the central axis A is orthogonal to the third rotation axis J3 and parallel to the fourth rotation axis J4. In other words, the central axis A is parallel to a direction in which the third arm and the fourth arm extend. Such an arrangement makes it easy to arrange the inertial sensor 3. Furthermore, the inertial sensor 3 is disposed at an end portion of the third arm 223 that is adjacent to the fourth joint 234, that is, an end portion of the third arm 223 on a side opposite to the third joint 233. Therefore, it is possible to dispose the inertial sensor 3 so as to be positioned as far away as possible from the third rotation axis J3, so that a higher acceleration Azs can be detected. Here, another example of the central axis A of an arm is an axis that is parallel to the direction in which the arm extends and passes through the center of gravity of the arm. The central axis A of an arm may also be an axis that is parallel to a line segment that connects the center of gravity of a joint whose distal end side is coupled to the arm to the center of gravity of a joint whose proximal end side is coupled to the arm. The inertial sensor 3 is disposed so as to acquire the acceleration Azs in a direction orthogonal to the central axis A of the arm on which the inertial sensor 3 is installed, so that the acceleration resulting from a rotational motion of the arm caused by the driving of at least one of the proximal end side joint and the distal end side joint can be detected with high accuracy.

Further, for example, when the motor M, which is a drive source, is disposed inside the third arm 223 as illustrated in FIG. 13, the inertial sensor 3 is disposed so as to be positioned away from the motor M. As a result, vibration caused by the driving of the motor M is less likely to be transmitted to the inertial sensor 3, so that the inertial sensor 3 can detect the angular velocity ωs and the acceleration Azs with high accuracy. The motor M disposed inside the third arm 223 may be the motor M included in any joint. For example, the motor M may be the motor M included in the third joint 233 or the motor M included in the fourth joint 234.

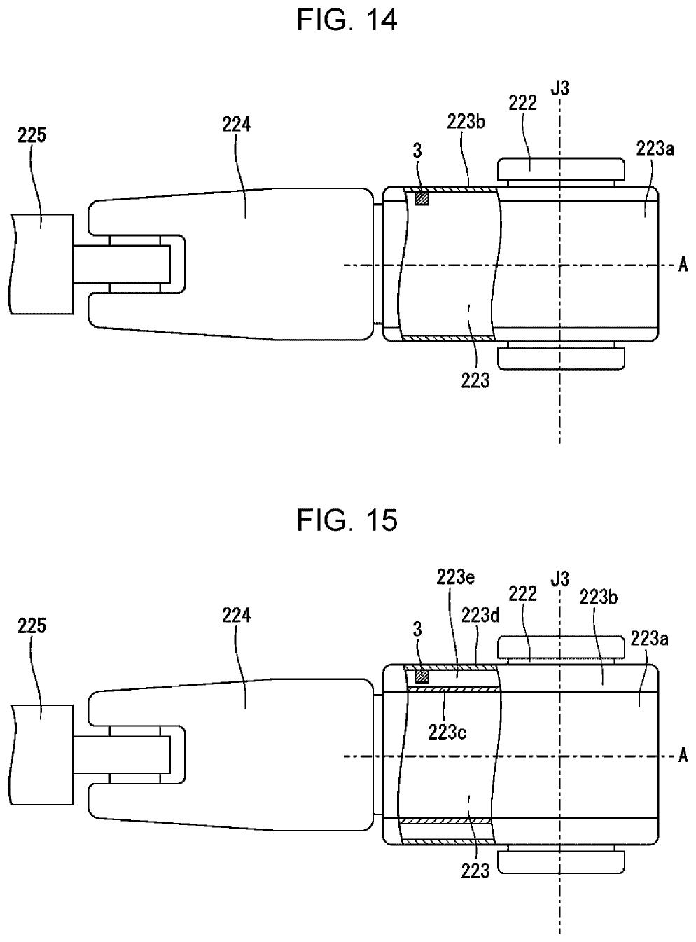

Further, for example, the inertial sensor 3 is disposed inside the third arm 223 as illustrated in FIG. 14. Therefore, it is possible to protect the inertial sensor 3 from moisture, dust, and the like. The inertial sensor 3 is disposed on a wall portion of the third arm 223. Specifically, the third arm 223 includes a housing 223a coupled to another arm and a cover 223b mounted on the housing 223a, and the inertial sensor 3 is disposed on a wall portion of the cover 223b. The speed reducer and the motor M are fixed to the housing 223a. Therefore, as the inertial sensor 3 is disposed on the cover 223b, vibrations caused by the speed reducer and the motor M are less likely to be transmitted to the inertial sensor 3. Therefore, the inertial sensor 3 can detect the angular velocity ωs and the acceleration Azs with high accuracy.

Further, for example, as illustrated in FIG. 15, the wall portion, that is, the cover 223b, has an inner wall 223c, an outer wall 223d, and a hollow portion 223e positioned between the inner wall 223c and the outer wall 223d, and the inertial sensor 3 is disposed in the hollow portion 223e. In this way, the inertial sensor 3 is housed inside the cover 223b, so that the inertial sensor 3 can be protected from moisture, dust, and the like. Furthermore, the inertial sensor 3 is disposed on the outer wall 223d. Therefore, vibrations caused by the speed reducer and the motor M are less likely to be transmitted to the inertial sensor 3. Therefore, the inertial sensor 3 can detect the angular velocity ωs and the acceleration Azs with high accuracy.

The robot system 1 has been described above. As described above, the robot system 1 includes: the robot 2 including the robot arm 22 that includes the first, second, third, fourth, fifth, and sixth arms 221, 222, 223, 224, 225, and 226 serving as a plurality of arms, and the first, second, third, fourth, fifth, and sixth joints 231, 232, 233, 234, 235, and 236 serving as a plurality of joints including the second joint 232 and the third joint 233, the second joint 232 serving as the proximal end side joint and having the second rotation axis J2, the third joint 233 serving as the distal end side joint positioned on a distal end side of the second joint 232 and having the third rotation axis J3, and the second rotation axis J2 and the third rotation axis J3 being parallel to each other; and the inertial sensor 3 disposed on the third arm 223 that connects the third joint 233 and the fourth joint 234 positioned at a position distal to the third joint 233, in which the inertial sensor 3 detects the angular velocity ωs around an axis parallel to the second and third rotation axes J2 and J3, and the acceleration Azs in a direction orthogonal to the central axis A of the third arm 223 on which the inertial sensor 3 is disposed and orthogonal to the second and third rotation axes J2 and J3. With such a configuration, the vibration amount of each of the second and third joints 232 and 233 can be detected based on the relationship between the angular velocity ωs and the acceleration Azs detected by the inertial sensor 3. Then, the vibration is controlled based on the vibration amount of each joint, so that it is possible to effectively reduce the vibration of the robot arm 22. In particular, as the inertial sensor 3 is disposed on the third arm 223, it is possible to detect the angular velocity ωs and the acceleration Azs regardless of the posture of the robot arm 22.

As described above, the robot system 1 includes: the robot 2 including the robot arm 22 that includes the first, second, third, fourth, fifth, and sixth arms 221, 222, 223, 224, 225, and 226 serving as a plurality of arms, and the first, second, third, fourth, fifth, and sixth joints 231, 232, 233, 234, 235, and 236 serving as a plurality of joints including the second joint 232 and the third joint 233, the second joint 232 serving as the proximal end side joint and having the second rotation axis J2, the third joint 233 serving as the distal end side joint positioned on a distal end side of the second joint 232 and having the third rotation axis J3, and the second rotation axis J2 and the third rotation axis J3 being parallel to each other; and the inertial sensor 3 disposed on an arm positioned between the third joint 233 and the sixth joint 236 positioned on the most distal end side, that is, any one of the third, fourth, and fifth arms 223, 224, and 225, in which the inertial sensor 3 detects the angular velocity ωs around an axis parallel to the second and third rotation axes J2 and J3, and the acceleration Azs in a direction orthogonal to the central axis A of the arm on which the inertial sensor 3 is disposed and orthogonal to the second and third rotation axes J2 and J3. With such a configuration, the vibration amount of each of the second and third joints 232 and 233 can be detected based on the relationship between the angular velocity ωs and the acceleration Azs detected by the inertial sensor 3. Then, the vibration is controlled based on the vibration amount of each joint, so that it is possible to effectively reduce the vibration of the robot arm 22. In particular, as the inertial sensor 3 is disposed so as to avoid the sixth arm 226 positioned at the most distal end, the number of joints between the inertial sensor 3 and the third joint 233 can be kept as small as possible. Therefore, it becomes easier to detect the angular velocity ωs and the acceleration Azs without being affected by the posture of the robot arm 22.

As described above, the robot 2 includes the base 21, and the robot arm 22 includes the first arm 221 coupled to the base 21 via the first joint 231 that is different from the proximal end side joint and the distal end side joint, the second arm 222 coupled to the first arm 221 via the second joint 232 serving as the proximal end side joint, and the third arm 223 coupled to the second arm 222 via the third joint 233 serving as the distal end side joint. The inertial sensor 3 is disposed on the third arm 223. With such a configuration, the detection axis of the angular velocity detection element 31a is maintained to be parallel to the second and third rotation axes J2 and J3 and the detection axis of the acceleration detection element 32a is maintained to be orthogonal to the second and third rotation axes J2 and J3 in any posture, so that the angular velocity ωs and the acceleration Azs can be detected more reliably.

As described above, the inertial sensor 3 is positioned on the central axis A of the third arm 223 in plan view when viewed from the direction orthogonal to the second and third rotation axes J2 and J3 and the central axis A of the third arm 223. Such an arrangement makes it easy to arrange the inertial sensor 3.

As described above, the inertial sensor 3 is disposed at the end portion of the third arm 223 on the side opposite to the third joint 233. Therefore, it is possible to dispose the inertial sensor 3 so as to be positioned as far away as possible from the third rotation axis J3, so that a higher acceleration Azs can be detected.

As described above, the robot 2 is disposed inside the third arm 223 and includes the motor M as a drive source for driving the robot arm 22. The inertial sensor 3 is disposed so as to be positioned away from the motor M. As a result, vibration caused by the driving of the motor M is less likely to be transmitted to the inertial sensor 3, so that the inertial sensor 3 can detect the angular velocity ωs and the acceleration Azs with high accuracy.

As described above, the inertial sensor 3 is disposed inside the third arm 223. Therefore, it is possible to protect the inertial sensor 3 from moisture, dust, and the like.

As described above, the inertial sensor 3 is disposed on the cover 223b which is the wall portion of the third arm 223. Therefore, vibrations caused by the speed reducer and the motor M are less likely to be transmitted to the inertial sensor 3. Therefore, the inertial sensor 3 can detect the angular velocity ωs and the acceleration Azs with high accuracy.

Further, as described above, the cover 223b, which is the wall portion, has the inner wall 223c, the outer wall 223d, and the hollow portion 223e positioned between the inner wall 223c and the outer wall 223d. The inertial sensor 3 is disposed in the hollow portion 223e. Therefore, it is possible to protect the inertial sensor 3 from moisture, dust, and the like.

### Second Embodiment

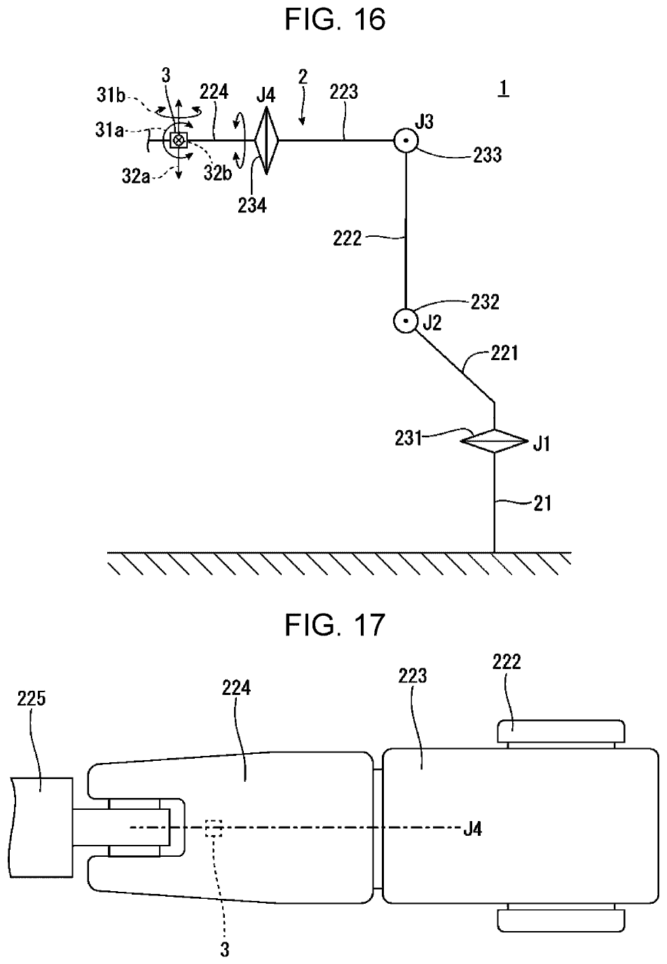

FIG. 16 is a schematic diagram illustrating a robot according to a second embodiment. FIG. 17 is a diagram illustrating an arrangement of an inertial sensor.

A robot system 1 according to the present embodiment is similar to the robot system 1 according to the first embodiment, except that a configuration and an arrangement of an inertial sensor 3 are different. In the following description, differences between the robot system 1 according to the present embodiment and the robot system 1 according to the first embodiment described above will be mainly described, and a description of the similar matters will be omitted. In addition, in each drawing of the present embodiment, the same components as those in the above-described embodiment are denoted by the same reference numerals.

As illustrated in FIG. 16, in the robot system 1 according to the present embodiment, the inertial sensor 3 is disposed on a fourth arm 224. The inertial sensor 3 detects an acceleration Azs in a direction orthogonal to a central axis of the fourth arm 224 and orthogonal to second and third rotation axes J2 and J3. As the inertial sensor 3 is disposed on the fourth arm 224 in this way, the inertial sensor 3 can be disposed so as to be positioned away from the second and third rotation axes J2 and J3, and thus, a higher acceleration Azs can be detected. Therefore, a vibration amount of each of a second joint 232 and a third joint 233 can be determined with higher accuracy.

In such a configuration, a detection axis of the inertial sensor 3 rotates with respect to the second and third rotation axes J2 and J3 as a fourth joint 234 rotates. Therefore, in a configuration in which one angular velocity detection element 31a and one acceleration detection element 32a are provided like the inertial sensor 3 according to the first embodiment described above, an angular velocity ωs and acceleration Azs cannot be detected depending on an orientation of the fourth joint 234.

Therefore, the inertial sensor 3 according to the present embodiment includes, in addition to the angular velocity detection element 31a, an angular velocity detection element 31b having a detection axis orthogonal to a detection axis of the angular velocity detection element 31a and a fourth rotation axis J4. Further, the inertial sensor 3 according to the present embodiment includes, in addition to the acceleration detection element 32a, an acceleration detection element 32b having a detection axis orthogonal to a detection axis of the acceleration detection element 32a and the fourth rotation axis J4. In other words, the inertial sensor 3 can detect angular velocities in two axial directions that are orthogonal to the fourth rotation axis J4 and orthogonal to each other, and accelerations in two axial directions that are orthogonal to the fourth rotation axis J4 and orthogonal to each other. With such a configuration, regardless of the orientation of the fourth joint 234, the angular velocity ωs can be detected based on the angular velocities detected by the angular velocity detection elements 31a and 31b, and the acceleration Azs can be detected based on the accelerations detected by the acceleration detection elements 32a and 32b.

Furthermore, as illustrated in FIG. 17, the inertial sensor 3 is disposed on the fourth rotation axis J4 of the fourth arm 224. Therefore, the positional relationship between the second and third rotation axes J2 and J3 and the inertial sensor 3 is kept constant regardless of an orientation of the fourth arm 224. Therefore, it is easy to calculate the angular velocity ωs and the acceleration Azs.

As described above, the robot system 1 according to the present embodiment includes: a robot 2 including a robot arm 22 that includes first, second, third, fourth, fifth, and sixth arms 221, 222, 223, 224, 225, and 226 serving as a plurality of arms, and first, second, third, fourth, fifth, and sixth joints 231, 232, 233, 234, 235, and 236 serving as a plurality of joints including the second joint 232 and the third joint 233, the second joint 232 serving as a proximal end side joint and having a second rotation axis J2, the third joint 233 serving as a distal end side joint positioned on a distal end side of the second joint 232 and having a third rotation axis J3, and the second rotation axis J2 and the third rotation axis J3 being parallel to each other; and the inertial sensor 3 disposed on the fourth arm 224 that connects the fourth joint 234 positioned at a position distal to the third joint 233, and the fifth joint 235 positioned at a position further distal to the third joint 233, in which the inertial sensor 3 detects the angular velocity ωs around an axis parallel to the second and third rotation axes J2 and J3, and the acceleration Azs in a direction orthogonal to the central axis of the fourth arm 224 on which the inertial sensor 3 is disposed and orthogonal to the second and third rotation axes J2 and J3. With such a configuration, the vibration amount of each of the second and third joints 232 and 233 can be detected based on the relationship between the angular velocity ωs and the acceleration Azs detected by the inertial sensor 3. Then, the vibration is controlled based on the vibration amount of each joint, so that it is possible to effectively reduce the vibration of the robot arm 22. In particular, as the inertial sensor 3 is disposed on the fourth arm 224, the inertial sensor 3 can be disposed so as to be positioned away from the second and third rotation axes J2 and J3, and thus, a higher acceleration Azs can be detected. Therefore, the vibration amount of each of the second joint 232 and the third joint 233 can be determined with higher accuracy.

As described above, the robot 2 includes the base 21, and the robot arm 22 includes the first arm 221 coupled to the base 21 via the first joint 231 that is different from the proximal end side joint and the distal end side joint, the second arm 222 coupled to the first arm 221 via the second joint 232 serving as the proximal end side joint, the third arm 223 coupled to the second arm 222 via the third joint 233 serving as the distal end side joint, and the fourth arm 224 coupled to the third arm 223 via the fourth joint 234 that is different from the proximal end side joint and the distal end side joint. Further, the inertial sensor 3 is disposed on the fourth arm 224, so that the inertial sensor 3 can detect the angular velocities around two axes that are orthogonal to the fourth rotation axis J4 and orthogonal to each other, and the accelerations in two axial directions that are orthogonal to the fourth rotation axis J4 and orthogonal to each other. With such a configuration, the angular velocity ωs and the acceleration Azs can be detected regardless of the orientation of the fourth joint 234. Further, it is possible to dispose the inertial sensor 3 so as to be positioned farther away from the second and third rotation axes J2 and J3, so that a higher acceleration Azs can be detected. Therefore, the vibration amount of each of the second joint 232 and the third joint 233 can be determined with higher accuracy.

As described above, the inertial sensor 3 is positioned on the fourth rotation axis J4, which is the rotation axis of the fourth arm 224. Therefore, a positional relationship between the second and third rotation axes J2 and J3 and the inertial sensor 3 is kept constant regardless of an orientation of the fourth arm 224. Therefore, it is easy to calculate the angular velocity ωs and the acceleration Azs.

The second embodiment can also achieve the same effect as the first embodiment.

### Third Embodiment

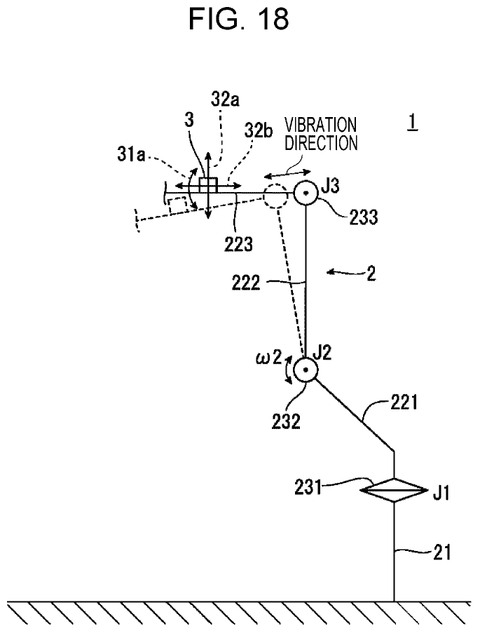

FIG. 18 is a schematic diagram illustrating a robot according to a third embodiment.

A robot system 1 according to the present embodiment is similar to the robot system 1 according to the first embodiment, except that a configuration of an inertial sensor 3 is different. In the following description, differences between the robot system 1 according to the present embodiment and the robot system 1 according to the first embodiment described above will be mainly described, and a description of the similar matters will be omitted. In addition, in each drawing of the present embodiment, the same components as those in the above-described embodiments are denoted by the same reference numerals.

For example, as illustrated in FIG. 9, when second and third arms 222 and 223 are in postures orthogonal to each other, an acceleration Azs resulting from vibration of a second joint 232 is low, and a translational velocity Vzs is also low. Therefore, there is a possibility that a vibration amount of each of the second joint 232 and a third joint 233 cannot be determined with high accuracy.

Therefore, as illustrated in FIG. 18, the inertial sensor 3 according to the present embodiment includes, in addition to an acceleration detection element 32a, an acceleration detection element 32b having a detection axis orthogonal to a detection axis of the acceleration detection element 32a and second and third rotation axes J2 and J3. With such a configuration, the detection axis of the acceleration detection element 32a is approximately the same as a direction of the acceleration resulting from the vibration of the second joint 232, so that a higher acceleration can be detected by the acceleration detection element 32b. Therefore, the vibration amount of each of the second joint 232 and the third joint 233 can be determined with high accuracy.

In FIG. 18, the vertical translational velocity Vzs of the inertial sensor 3 is expressed as Vzs=L2×ω2+√(L3²+Lsz²)×ω3, and a horizontal translational velocity Vxs is expressed as Vxs=L2×ω2. Therefore, the following Equation (7) holds. Then, the vibration amount of each of the second joint 232 and the third joint 233 can be determined based on values of angular velocities ω2 and ω3 calculated by Equation (7).

$$\begin{matrix}Equation ( 7 ) & \\ [ \begin{matrix}Vzs \\ ω s \\ Vxs\end{matrix} ] = [ \begin{matrix}L 31 & \sqrt{L {3}^{2} + L s {z}^{2}} \\ 1 & 1 \\ L 21 & 0\end{matrix} ] [ \begin{matrix}ω 2 \\ ω 3\end{matrix} ] & ( 7 )\end{matrix}$$

The third embodiment can also achieve the same effect as the first embodiment.

### Fourth Embodiment

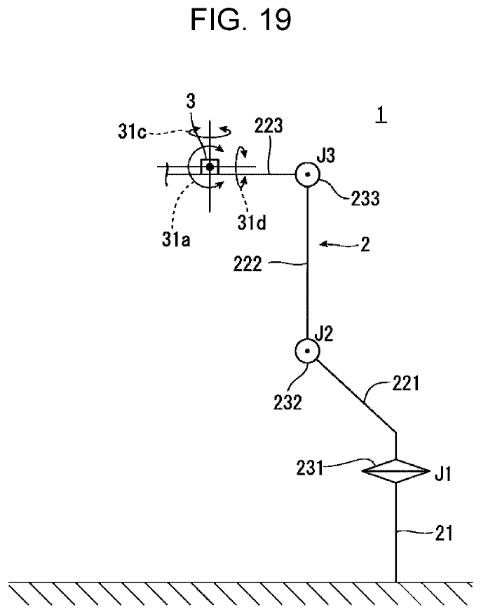

FIG. 19 is a schematic diagram illustrating a robot according to a fourth embodiment.

A robot system 1 according to the present embodiment is similar to the robot system 1 according to the first embodiment, except that a configuration of an inertial sensor 3 is different. In the following description, differences between the robot system 1 according to the present embodiment and the robot system 1 according to the first embodiment described above will be mainly described, and a description of the similar matters will be omitted. In addition, in each drawing of the present embodiment, the same components as those in the above-described embodiments are denoted by the same reference numerals.

In the robot system 1 according to the present embodiment, the inertial sensor 3 is configured to detect vibration around a first rotation axis J1 of a first joint 231. Specifically, as illustrated in FIG. 19, the inertial sensor 3 according to the present embodiment includes, in addition to an angular velocity detection element 31a, angular velocity detection elements 31c and 31d having detection axes orthogonal to a detection axis of the angular velocity detection element 31a and orthogonal to each other. With such a configuration, it is possible to detect the vibration around the first rotation axis J1 of the first joint 231 based on angular velocities detected by the angular velocity detection elements 31c and 31d, regardless of orientations of second and third joints 232 and 233. For convenience of explanation, the acceleration detection element 32a is not illustrated.

The fourth embodiment can also achieve the same effect as the first embodiment.

### Fifth Embodiment

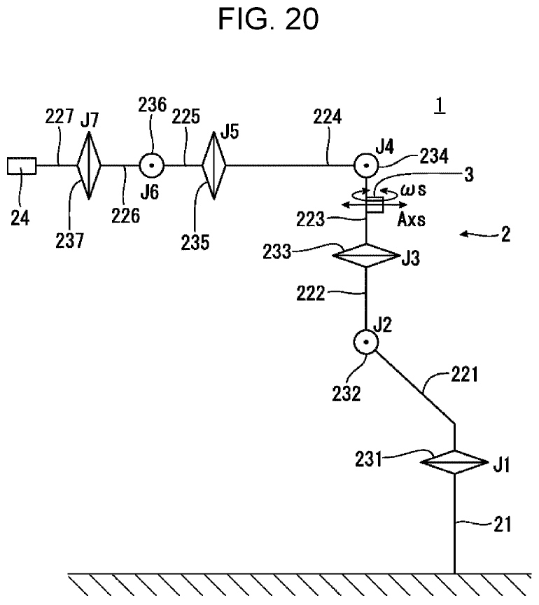

FIG. 20 is a schematic diagram illustrating a robot according to a fifth embodiment.

A robot system 1 according to the present embodiment is similar to the robot system 1 according to the first embodiment, except that a configuration of a robot 2 and an arrangement of an inertial sensor 3 corresponding thereto are different. In the following description, differences between the robot system 1 according to the present embodiment and the robot system 1 according to the first embodiment described above will be mainly described, and a description of the similar matters will be omitted. In addition, in each drawing of the present embodiment, the same components as those in the above-described embodiments are denoted by the same reference numerals.

As illustrated in FIG. 20, the robot 2 according to the present embodiment is a 7-axis vertical articulated robot having seven drive axes. A robot arm 22 has a configuration in which first, second, third, fourth, fifth, sixth, and seventh arms 221, 222, 223, 224, 225, 226, and 227 are coupled via first, second, third, fourth, fifth, sixth, and seventh joints 231, 232, 233, 234, 235, 236, and 237.

Specifically, the first arm 221 is coupled to a base 21 via the first joint 231 so as to be rotatable around a first rotation axis J1. The second arm 222 is coupled to the first arm 221 via the second joint 232 so as to be rotatable around a second rotation axis J2. The third arm 223 is coupled to the second arm 222 via the third joint 233 so as to be rotatable around a third rotation axis J3. The fourth arm 224 is coupled to the third arm 223 via the fourth joint 234 so as to be rotatable around a fourth rotation axis J4. The fifth arm 225 is coupled to the fourth arm 224 via the fifth joint 235 so as to be rotatable around a fifth rotation axis J5. The sixth arm 226 is coupled to the fifth arm 225 via the sixth joint 236 so as to be rotatable around a sixth rotation axis J6. The seventh arm 227 is coupled to the sixth arm 226 via the seventh joint 237 so as to be rotatable around a seventh rotation axis J7.

Among the first to seventh joints 231, 232, 233, 234, 235, 236, and 237, the second, fourth, and sixth joints 232, 234, and 236 are bending joints, and the first, third, fifth, and seventh joints 231, 233, 235, and 237 are twisting joints. The second rotation axis J2 is orthogonal to the first rotation axis J1, the third rotation axis J3 is orthogonal to the second rotation axis J2, the fourth rotation axis J4 is orthogonal to the third rotation axis J3, the fifth rotation axis J5 is orthogonal to the fourth rotation axis J4, the sixth rotation axis J6 is orthogonal to the fifth rotation axis J5, and the seventh rotation axis J7 is orthogonal to the sixth rotation axis J6.

The inertial sensor 3 is disposed on the third arm 223. The inertial sensor 3 can detect an angular velocity ωs around an axis parallel to the third rotation axis J3 and an acceleration Axs in a direction orthogonal to the third rotation axis J3.

In such a robot 2, the first joint 231 is the “proximal end side joint” of the present application, and the third joint 233 is the “distal end side joint” of the present application. That is, in the robot 2, the second joint 232 is positioned between the proximal end side joint and the distal end side joint. In the robot 2, when an orientation of the second joint 232 is a predetermined orientation, the first rotation axis J1 of the first joint 231, which is the proximal end side joint, and the third rotation axis J3 of the third joint 233, which is the distal end side joint, are parallel to each other as illustrated in FIG. 20. Therefore, a vibration amount of each of the first joint 231 and the third joint 233 can be detected in the same manner as in the first embodiment described above.

As described above, the robot 2 according to the present embodiment includes the base 21. The robot arm 22 includes the first arm 221 coupled to the base 21 via the first joint 231 serving as the proximal end side joint, the second arm 222 coupled to the first arm 221 via the second joint 232 that is different from the proximal end side joint and the distal end side joint, and the third arm 223 coupled to the second arm 222 via the third joint 233 serving as the distal end side joint. The inertial sensor 3 is disposed on the third arm 223. With such a configuration, when the orientation of the second joint 232 is a predetermined orientation, the first rotation axis J1 of the first joint 231 which is the proximal end side joint, and the third rotation axis J3 of the third joint 233 serving as the distal end side joint are parallel to each other, so that the vibration amount of each of the first and third joints 231 and 233 can be detected.

The fifth embodiment can also achieve the same effect as the first embodiment.

### Sixth Embodiment

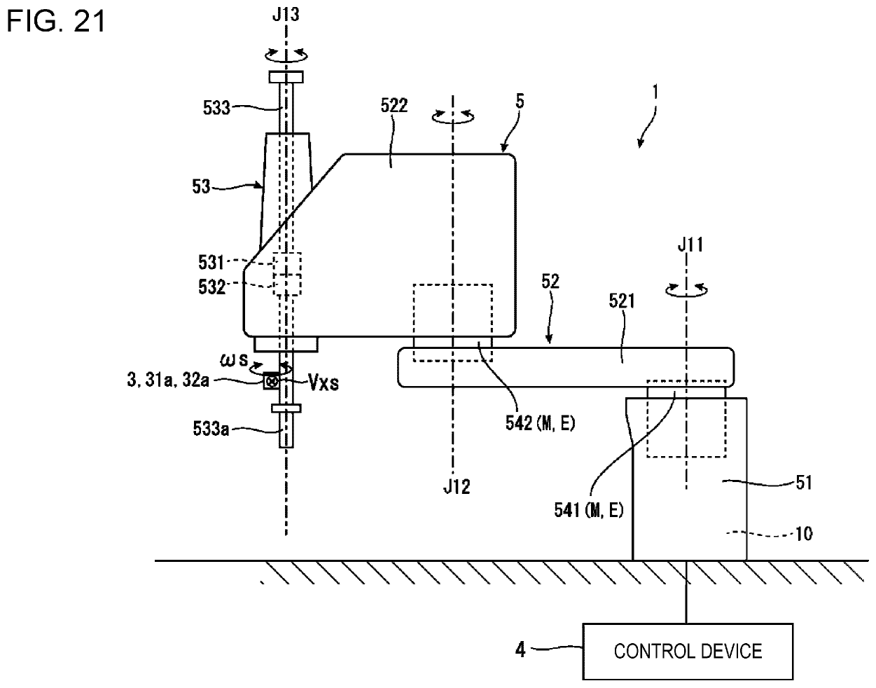

FIG. 21 is a schematic diagram illustrating a robot according to a sixth embodiment.

A robot system 1 according to the present embodiment is similar to the robot system 1 according to the first embodiment, except that a configuration of a robot 5 and an arrangement of an inertial sensor 3 corresponding thereto are different. In the following description, differences between the robot system 1 according to the present embodiment and the robot system 1 according to the first embodiment described above will be mainly described, and a description of the similar matters will be omitted. In addition, in each drawing of the present embodiment, the same components as those in the above-described embodiments are denoted by the same reference numerals.

As illustrated in FIG. 21, the robot 5 according to the present embodiment is a horizontal articulated robot (SCARA robot). Such a robot 5 includes a base 51 and a robot arm 52 coupled to the base 51. The robot arm 52 has a configuration in which first and second arms 521 and 522 are coupled via first and second joints 541 and 542.

The first arm 521 is coupled to the base 51 via the first joint 541 so as to be rotatable around a first rotation axis J11. The second arm 522 is coupled to the first arm 521 via the second joint 542 so as to be rotatable around a second rotation axis J12. The first and second joints 541 and 542 are twisting joints, and the first and second rotation axes J11 and J12 are parallel to each other and are aligned with the vertical direction.

A work head 53 is provided at a distal end portion of the second arm 522. The work head 53 includes a spline nut 531, a ball screw nut 532, and a spline shaft 533, the spline nut 531 and the ball screw nut 532 being coaxially arranged at the distal end portion of the second arm 522, and the spline shaft 533 being a main shaft inserted through the spline nut 531 and the ball screw nut 532. The spline shaft 533 is rotatable around a third rotation axis J13, which is a central axis of the spline shaft 533 and is aligned with the vertical direction, with respect to the second arm 522, and is movable (raised and lowered) along the third rotation axis J13. A mounting portion 533a for mounting an end effector (not illustrated) is provided at a lower end portion of the spline shaft 533. The end effector is attachable to and detachable from the mounting portion 533a, and an end effector suitable for intended work is appropriately selected. The third rotation axis J13 is aligned with the vertical direction and is parallel to the first and second rotation axes J11 and J12.

In such a robot 5, the first joint 541 is the “proximal end side joint” of the present application, and the second joint 542 is the “distal end side joint” of the present application.

Each of the joints 541 and 542 includes a motor M, a speed reducer (not illustrated) that reduces a rotation speed of the motor M and outputs the reduced rotation speed, and an encoder E that detects a rotation amount of the motor M.

As illustrated in FIG. 21, the inertial sensor 3 is disposed on the second arm 522. The inertial sensor 3 includes an angular velocity detection element 31a that detects an angular velocity ωs around an axis in the same direction as the first and second rotation axes J11 and J12, and an acceleration detection element 32a that detects an acceleration Axs in a direction orthogonal to the first and second rotation axes J11 and J12.

Also in the robot system 1 having such a configuration, a vibration amount of each of the first joint 541 and the second joint 542 can be detected in the same manner as in the first embodiment described above.

The sixth embodiment can also achieve the same effect as the first embodiment.

The control method for the robot and the robot system according to the present disclosure have been described above based on the illustrated embodiments, but the present disclosure is not limited thereto, and a configuration or procedure of each component can be replaced with any configuration or procedure having a similar function. Any other configuration or procedure may be added to the present disclosure. The embodiments may also be combined as appropriate.

1. A robot system comprising:
a robot including a robot arm that includes a plurality of arms and a plurality of joints, the plurality of joints including a proximal end side joint and a distal end side joint positioned on a distal end side of the proximal end side joint, and the proximal end side joint and the distal end side joint having rotation axes parallel to each other; and
an inertial sensor disposed on an arm that connects the distal end side joint and a joint positioned at a position distal to the distal end side joint,
wherein the inertial sensor detects an angular velocity around an axis parallel to the rotation axes, and an acceleration in a direction orthogonal to a central axis of the arm on which the inertial sensor is disposed and orthogonal to the rotation axes.

2. A robot system comprising:
a robot including a robot arm that includes a plurality of arms and a plurality of joints, the plurality of joints including a proximal end side joint and a distal end side joint positioned on a distal end side of the proximal end side joint, and the proximal end side joint and the distal end side joint having rotation axes parallel to each other; and
an inertial sensor disposed on an arm that connects a joint positioned at a position distal to the distal end side joint and a joint positioned at a position further distal to the distal end side joint,
wherein the inertial sensor detects an angular velocity around an axis parallel to the rotation axes, and an acceleration in a direction orthogonal to a central axis of the arm on which the inertial sensor is disposed and orthogonal to the rotation axes.

3. A robot system comprising:
a robot including a robot arm that includes a plurality of arms and a plurality of joints, the plurality of joints including a proximal end side joint and a distal end side joint positioned on a distal end side of the proximal end side joint, and the proximal end side joint and the distal end side joint having rotation axes parallel to each other; and
an inertial sensor disposed on an arm that is positioned between the distal end side joint and a joint positioned on a most distal end side,
wherein the inertial sensor detects an angular velocity around an axis parallel to the rotation axes, and an acceleration in a direction orthogonal to a central axis of the arm on which the inertial sensor is disposed and orthogonal to the rotation axes.

4. The robot system according to claim 1, wherein
the robot includes a base,
the robot arm includes a first arm coupled to the base via a joint that is different from the proximal end side joint and the distal end side joint, a second arm coupled to the first arm via the proximal end side joint, and a third arm coupled to the second arm via the distal end side joint, and
the inertial sensor is disposed on the third arm.

5. The robot system according to claim 4, wherein the inertial sensor is positioned on a central axis of the third arm in plan view when viewed from a direction orthogonal to the rotation axes and the central axis of the third arm.

6. The robot system according to claim 4, wherein the inertial sensor is disposed at an end portion of the third arm on a side opposite to the distal end side joint.

7. The robot system according to claim 4, wherein
the robot includes a drive source that is disposed inside the third arm and drives the robot arm, and
the inertial sensor is disposed so as to be positioned away from the drive source.

8. The robot system according to claim 4, wherein the inertial sensor is disposed inside the third arm.

9. The robot system according to claim 8, wherein the inertial sensor is disposed on a wall portion of the third arm.

10. The robot system according to claim 9, wherein
the wall portion has an inner wall, an outer wall, and a hollow portion positioned between the inner wall and the outer wall, and
the inertial sensor is disposed in the hollow portion.

11. The robot system according to claim 2, wherein
the robot includes a base,
the robot arm includes a first arm coupled to the base via a joint that is different from the proximal end side joint and the distal end side joint, a second arm coupled to the first arm via the proximal end side joint, a third arm coupled to the second arm via the distal end side joint, and a fourth arm coupled to the third arm via a joint that is different from the proximal end side joint and the distal end side joint,
the inertial sensor is disposed on the fourth arm, and
the inertial sensor detects angular velocities around two axes that are orthogonal to a rotation axis of the fourth arm and are orthogonal to each other, and accelerations in two axial directions that are orthogonal to the rotation axis of the fourth arm and are orthogonal to each other.

12. The robot system according to claim 11, wherein the inertial sensor is positioned on the rotation axis of the fourth arm.

13. The robot system according to claim 1, wherein
the robot includes a base,
the robot arm includes a first arm coupled to the base via the proximal end side joint, a second arm coupled to the first arm via a joint that is different from the proximal end side joint and the distal end side joint, and a third arm coupled to the second arm via the distal end side joint, and
the inertial sensor is disposed on the third arm.
